(19) United States
(12) Patent Application Publication
(10) Pub. No.: US 2025/0279744 A1
(43) Pub. Date: Sep. 4, 2025

(54) SOLAR MODULE FRAMES AND INSTALLATION

(71) Applicant: Nextracker LLC, Fremont, CA (US)

(72) Inventors: Alexander W. AU, Oakland, CA (US); Madeleine Davis Kho, Oakland, CA (US)

(21) Appl. No.: 19/055,921

(22) Filed: Feb. 18, 2025

Related U.S. Application Data
(60) Provisional application No. 63/559,251, filed on Feb. 29, 2024.

(51) Int. Cl. H02S 20/32; H02S 30/10

(52) U.S. Cl. CPC H02S 20/32; H02S 30/10

(57) ABSTRACT

A method for coupling a first solar module frame and a second solar module frame to a torque tube includes: placing a rail at the torque tube; placing a first outward extending flange of the first solar module frame at the rail; placing a second outward extending flange of the second solar module frame over the first outward extending flange at the rail; and inserting a fastener at the second outward extending flange, the first outward extending flange, and the rail.

### RELATED APPLICATION

This disclosure claims priority to U.S. provisional patent application No. 63/559,251, filed on Feb. 29, 2024, the content of which is hereby incorporated by reference.

### TECHNICAL FIELD

This disclosure relates generally to device, system, and method embodiments of solar module frames, solar tracker systems, and solar module frame installation. Solar module frame related embodiments disclosed herein can be configured to facilitate more efficient installation of one or more solar modules to a support structure, such as at a torque tube of a solar tracker.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant cost to a solar tracking system application.

### SUMMARY

This disclosure in general describes device, system, and method embodiments relating to solar module frames and installation of such solar module frames. Solar module frame related embodiments disclosed herein can be configured to facilitate more efficient and effective coupling installation of one or more solar module frames at a support structure. For example, solar module frame related embodiments disclosed herein can be configured to facilitate more efficient and effective installation of one or more solar module frames to a torque tube. In some such examples, solar module frame and method embodiments disclosed herein can be configured to facilitate automated (e.g., autonomous, such as fully or partially robotic) installation of one or more solar modules to a torque tube using one or more embodiments disclosed herein. As such, frame structure and installation features disclosed herein can be useful in adapting solar module frames and associated installation of these solar module frames for more automated installation at a torque tube on site at a solar trackers.

One embodiment includes a method for coupling a first solar module frame and a second solar module frame to a torque tube. This method embodiment includes the steps of: placing a rail at the torque tube; placing a first outward extending flange of the first solar module frame at the rail; placing a second outward extending flange of the second solar module frame over the first outward extending flange at the rail; and inserting a fastener at the second outward extending flange, the first outward extending flange, and the rail.

In a further embodiment of this method, the second outward extending flange can be placed over the first outward extending flange at the rail after the first outward extending flange is placed at the rail. In some such examples, the second outward extending flange is placed over the first outward extending flange at the rail by stacking the second outward extending flange on top of the first outward extending flange at the rail. In one particular such example, the first outward extending flange can be placed at the rail to directly contact the rail and the second outward extending flange can be stacked on top of the first outward extending flange at the rail such that the second outward extending flange directly contacts the first outward extending flange. In another particular such example, the first outward extending flange of the first solar module frame extends horizontally outward from a first sidewall of the first solar module frame, the second outward extending flange of the second solar module frame extends horizontally outward from a second sidewall of the second solar module frame, and the second outward extending flange is stacked on top of the first outward extending flange at the rail to define a fastening gap between the first sidewall of the first solar module frame, the second sidewall of the second solar module frame, and the stacked first and second outward extending flanges. In some such examples, the fastening gap can be open at a top side that is opposite the rail. For instance, inserting the fastener at the second outward extending flange, the first outward extending flange, and the rail can include inserting the fastener through the fastening gap from the top side that is opposite the rail. In one such instance, inserting the fastener through the fastening gap from the top side that is opposite the rail can include inserting the fastener through the fastening gap from the top side, then through the second outward extending flange, then through the first outward extending flange, and then into the rail. In some examples, the first solar module frame can further include a first photovoltaic receptacle that extends horizontally outward from the first sidewall in a direction opposite the first outward extending flange and opposite the fastening gap, and the second solar module frame can further include a second photovoltaic receptacle that extends horizontally outward from the second sidewall in a direction opposite the second outward extending flange and opposite the fastening gap.

In a further embodiment of this method, after placing the rail at the torque tube and before placing the first and second outward extending flanges at the rail, the method can include inserting a second fastener at the rail to couple the rail to the torque tube.

In a further embodiment of this method, the fastener can be inserted at the second outward extending flange, the first outward extending flange, and the rail through an open top side of a fastening gap that is defined between first solar module frame and the second solar module frame. For instance, the fastening gap can define a fastening gap width, and the fastening gap width can be greater than a width of the fastener.

Another embodiment includes a solar module coupling system. This system embodiment includes a first solar module frame, a second solar module frame, and a fastener. The first solar module frame includes a first sidewall, a first outward extending flange that extends out horizontally from the first sidewall, and a first photovoltaic receptacle that extends out horizontally from the first sidewall in a direction opposite the first outward extending flange. The second solar module frame includes a second sidewall, a second outward extending flange that extends out horizontally from the second sidewall, and a second photovoltaic receptacle that extends out horizontally from the second sidewall in a direction opposite the second outward extending flange. The second outward extending flange is configured to overlay the first outward extending flange. The fastener is configured to couple the first and second solar module frames to a rail at a torque tube. When the second outward extending flange overlays first outward extending flange, the fastener is configured to extend through the overlaid first and second outward extending flanges and into the rail at the torque tube.

In a further embodiment of this system, when the second outward extending flange overlays first outward extending flange, the first and second outward extending flanges are configured to create a fastening gap between the first sidewall of the first solar module frame, the second sidewall of the second solar module frame, and the overlaid first and second outward extending flanges. In one example, the fastener can be configured to be inserted through the fastening gap from a top side of the first and second solar modules frames opposite a bottom side of the first and second solar modules frames configured to interface with a torque tube.

In a further embodiment of this system, the first sidewall extends vertically, at a normal angle relative to the first outward extending flange, between the first outward extending flange and the first photovoltaic receptacle, and the second sidewall extends vertically, at a normal angle relative to the second outward extending flange, between the second outward extending flange and the second photovoltaic receptacle. In one example, the first photovoltaic receptacle is defined, at least in part, by a free-floating end of a first photovoltaic receptacle wall that extends in a direction opposite the first outward extending flange, and the second photovoltaic receptacle is defined, at least in part, by a free-floating end of a second photovoltaic receptacle wall that extends in a direction opposite the second outward extending flange.

In a further embodiment of this system, the first sidewall extends vertically, at a skewed angle relative to the first outward extending flange, between the first outward extending flange and the first photovoltaic receptacle, and the second sidewall extends vertically, at a skewed angle relative to the second outward extending flange, between the second outward extending flange and the second photovoltaic receptacle. In one example, the first sidewall includes a first corrugated portion that extends vertically, at the skewed angle relative to the first outward extending flange, between the first outward extending flange and the first photovoltaic receptacle, and the second sidewall includes a second corrugated portion that extends vertically, at the skewed angle relative to the second outward extending flange, between the second outward extending flange and the second photovoltaic receptacle.

In a further embodiment of this system, the first solar module frame further includes a first plurality of damping slots at the first sidewall and the second solar module frame further includes a second plurality of damping slots at the second sidewall. The first plurality of damping slots can be configured to permit flexing of the first sidewall, and the second plurality of damping slots can be configured to permit flexing of the second sidewall.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a schematic, perspective view of a solar tracker apparatus.

FIGS. 2A-2C illustrate one embodiment of a solar module coupling system. FIG. 2A is an exploded, perspective view of first and second solar module frames and a rail of this system embodiment to be coupled to a torque tube, FIG. 2B is a perspective view of the first solar module frame and the rail coupled to the torque tube (with the second solar module frame removed for ease of visibility of the first solar module frame at the rail), and FIG. 2C is a side elevational view of the first and second solar module frames and the rail coupled to the torque tube.

FIGS. 3A-3C illustrate another embodiment of a solar module coupling system. FIG. 3A is a side elevational view of a first solar module frame of this system embodiment to be coupled to a torque tube, FIG. 3B is a close-up side elevational view of a side end portion of the first solar module frame of FIG. 3A, and FIG. 3C is a close-up side elevational view of three side end portions of three solar module frames of FIG. 3B stacked on top of one another.

FIGS. 4A-4C illustrate an additional embodiment of a solar module coupling system. FIG. 4A is a side elevational view of a first solar module frame of this system embodiment to be coupled to a torque tube, FIG. 4B is a close-up side elevational view of a side end portion of the first solar module frame of FIG. 4A, and FIG. 4C is a side elevational view of the first and second solar module frames as shown at FIG. 4A along with a rail coupled to the torque tube.

FIG. 5 is a side elevational view of another embodiment of a solar module frame, with FIG. 5 showing a side elevational view of first and second solar module frames according to this embodiment and a rail coupled to the torque tube.

FIGS. 6A-6B illustrate an additional embodiment of a solar module coupling system. FIG. 6A is an exploded, perspective view of first and second solar module frames and a rail of this system embodiment to be coupled to a torque tube, and FIG. 6B is a side elevational view of the first and second solar module frames as shown at FIG. 6A along with a rail coupled to the torque tube.

FIG. 7 is a flow diagram of an embodiment of a method for coupling a first solar module frame and a second solar module frame to a torque tube.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

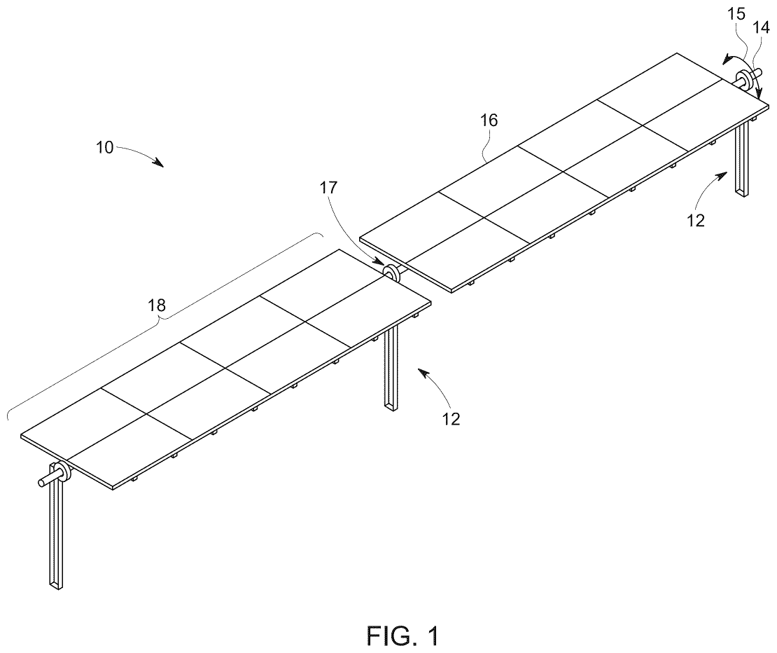

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and be rotatably supported at each pier 12. The solar tracker apparatus 10 can further include a plurality of solar modules 16 (e.g., solar panels having photovoltaic cells) supported at the respective torque tube 14. The one or more torque tubes 14 can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 can be referred to as a bay 18 and, for example, in certain applications may be generally in the range of about 8 meters in length and each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame 100 that is coupled to the torque tube 14. As will be described herein, in some instances, the solar module frame 100 can be directly coupled to the torque tube 14 and in other instances the solar module frame 100 can be indirectly coupled to the torque tube 14 by coupling the solar module frame 100 directly to a rail and coupling that rail to the torque tube 14. As will also be described herewith, in various embodiments, adjacent solar module frames 100 of adjacent solar modules 16 can be coupled together. The following disclosure will describe various solar module frame embodiments that can be used, for instance, in a solar tracker apparatus. Such embodiments disclosed herein can be useful in facilitating more labor-efficient solar module frame installation at a solar tracker apparatus and/or reduced material costs by reducing frame material and/or a number of fasteners associated with coupling solar module frames to the torque tube.

Solar module frame related embodiments disclosed herein can be configured to help facilitate more efficient and effective coupling installation of one or more solar module frames to a torque tube. In some such examples, solar module frame and method embodiments disclosed herein can be configured to facilitate automated (e.g., autonomous, such as fully or partially robotic) installation of one or more solar modules to a torque tube using one or more embodiments disclosed herein. As such, frame structure and installation features disclosed herein can be useful in adapting solar module frames and associated installation of these solar module frames for more automated installation at a torque tube on site at a solar tracker, for instance such as that shown at the example of FIG. 1. These solar module frame coupling embodiments will be discussed as follows in conjunction with the accompanying drawing figures. The illustrated embodiments are examples of the inventive concepts disclosed herein and as such it should be noted that features of various illustrated solar module frame coupling embodiments can be intermixed and combined for certain applications as appropriate.

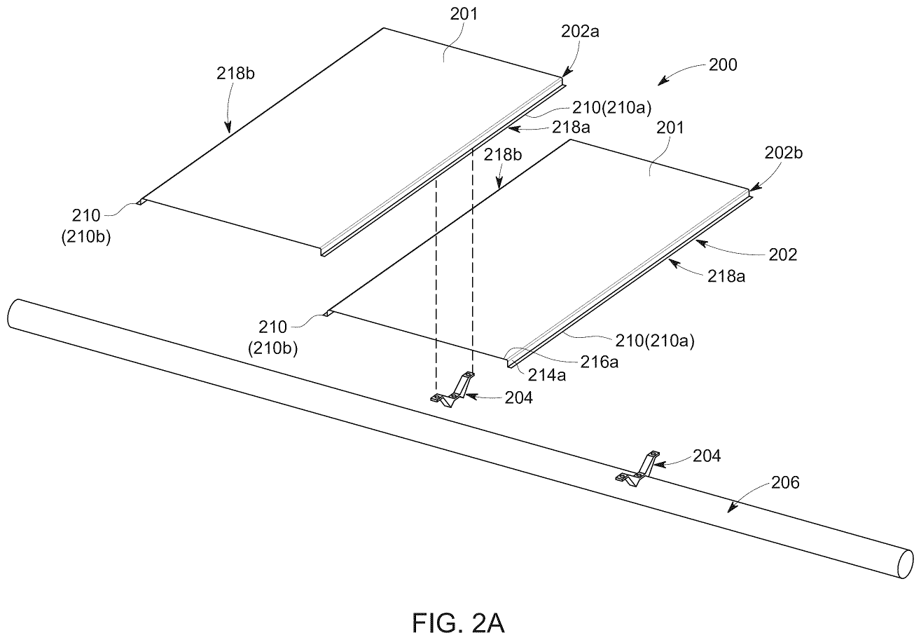

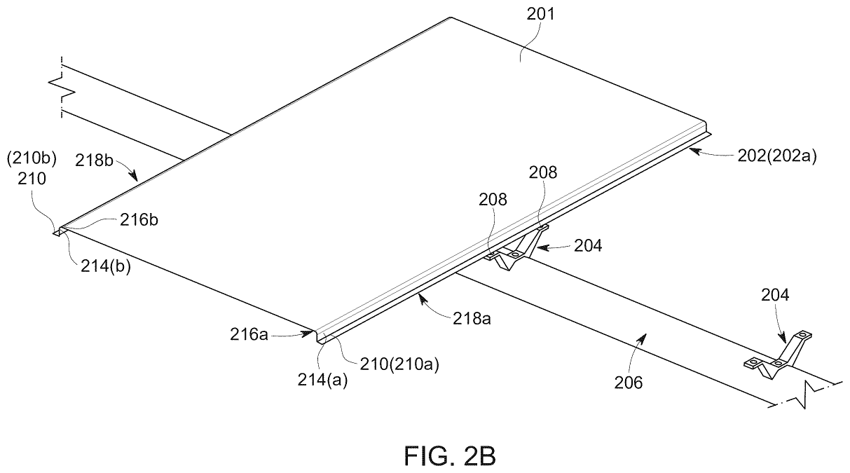

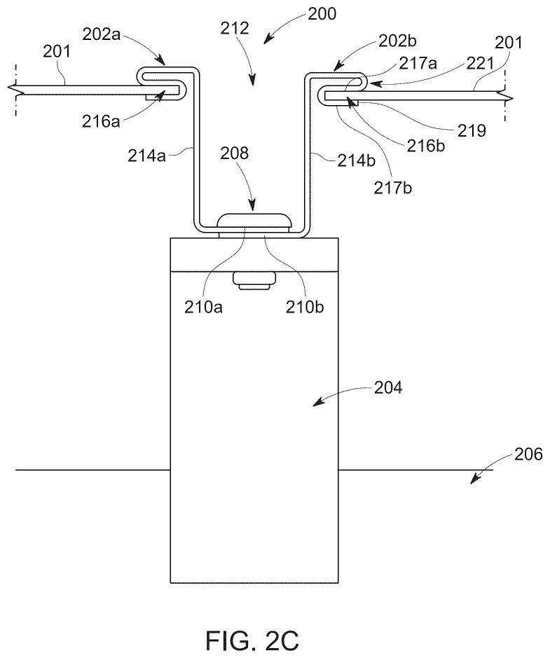

FIGS. 2A-2C illustrate one embodiment of a solar module coupling system 200. FIG. 2A is an exploded, perspective view of solar module frames 202—including a first solar module frame 202a and a second solar module frame 202b—and a rail 204 of this system 200 to be coupled to a torque tube 206. FIG. 2B is a perspective view of the first solar module frame 202a and the rail 204 coupled to the torque tube 206 (the second solar module frame 202b is removed in FIG. 2B for ease of visibility of the first solar module frame 202a at the rail 204), and FIG. 2C is a side elevational view of the first and second solar module frames 202a, 202b and the rail 204 coupled to the torque tube 206.

The solar module coupling system 200 can include the first solar module frame 202a, the second solar module frame 202b, and at least one fastener 208. Each of the first and second solar module frames 202a, 202b can include at least one an outward extending flange 210. The outward extending flange 210 at each of the first and second solar module frames 202a, 202b can be configured to interface with one another and receive the same fastener 208 at each of the interfacing outward extending flanges 210. The structure of the first and second solar module frames 202a, 202b, including the outward extending flange 210 at interfacing sides of the first and second solar module frames 202a, 202b, can be configured to create a fastening gap 212 between interfacing sidewalls of the first and second solar module frames 202a, 202b and this fastening gap 212 can be useful in increasing solar module frame installation efficiency at the torque tube 206.

The first solar module frame 202a can include a first sidewall 214a, a first outward extending flange 210a, and a first photovoltaic receptacle 216a. The first outward extending flange 210a can extend out, for instance extend out horizontally as shown for the illustrated embodiment, from the first sidewall 214a. The first photovoltaic receptacle 216a can extend out, for instance extend out horizontally as shown for the illustrated embodiment, from the first sidewall 214a in a direction opposite the first outward extending flange 210a. As shown here, the first sidewall 214a, the first outward extending flange 210a, and the first photovoltaic receptacle 216a can be at a first side 218a (e.g., a first longitudinal side) of the first solar module frame 202a. At a second side 218b (e.g., a second longitudinal side) opposite the first side 218a, the first solar module frame 202a can likewise include a second sidewall 214b, a second outward extending flange 210b, and a second photovoltaic receptacle 216b. The second outward extending flange 210b can extend out, for instance extend out horizontally as shown for the illustrated embodiment, from the second sidewall 214b. The second photovoltaic receptacle 216b can extend out, for instance extend out horizontally as shown for the illustrated embodiment, from the second sidewall 214b in a direction opposite the second outward extending flange 210b. Photovoltaic cells (e.g., a laminate member that includes photovoltaic cells) can be retained at the first solar module frame 202a between the first and second photovoltaic receptacles 216a, 216b.

The second solar module frame 202b can be similar to, or the same as, the first solar module frame 202a. The second solar module frame 202b can include first sidewall 214a, first outward extending flange 210a, and first photovoltaic receptacle 216a. The first outward extending flange 210a of the second solar module frame 202b can extend out, for instance extend out horizontally as shown for the illustrated embodiment of the second solar module frame 202b, from the first sidewall 214a of the second solar module frame 202b. The first photovoltaic receptacle 216a of the second solar module frame 202b can extend out, for instance extend out horizontally as shown for the illustrated embodiment, from the first sidewall 214a of the second solar module frame 202b in a direction opposite the first outward extending flange 210a of the second solar module frame 202b. As shown here, the first sidewall 214a, the first outward extending flange 210a, and the first photovoltaic receptacle 216a can be at first side 218a (e.g., a first longitudinal side) of the second solar module frame 202b. At second side 218b (e.g., a second longitudinal side) opposite first side 218a, the second solar module frame 202b can likewise include second sidewall 214b, second outward extending flange 210b, and second photovoltaic receptacle 216b. The second outward extending flange 210b of the second solar module frame 202b can extend out, for instance extend out horizontally as shown for the illustrated embodiment, from the second sidewall 214b of the second solar module frame 202b. The second photovoltaic receptacle 216b of the second solar module frame 202b can extend out, for instance extend out horizontally as shown for the illustrated embodiment, from the second sidewall 214b of the second solar module frame 202b in a direction opposite the second outward extending flange 210b of the second solar module frame 202b. Photovoltaic cells (e.g., a laminate member that includes photovoltaic cells) can be retained at the first solar module frame 202a between the first and second photovoltaic receptacles 216a, 216b.

The embodiment shown at FIGS. 2A-2C includes the sidewalls 214a, 214b at each of the first and second solar module frames 202a, 202b as vertically extending sidewalls 214a, 214b. More specifically, for this illustrated embodiment, the first sidewall 214a extends vertically, at a normal angle relative to the first outward extending flange 210a, between the first outward extending flange 210a and the first photovoltaic receptacle 216a. Similarly, for this illustrated embodiment, the second sidewall 214b extends vertically, at a normal angle relative to the second outward extending flange 210b, between the second outward extending flange 210b and the second photovoltaic receptacle 216b. The photovoltaic receptacle 216a can extend along a first plane that is parallel to a second plane along which the outward extending flange 210a extends, and, similarly, the photovoltaic receptacle 216b can extend along a first plane that is parallel to a second plane along which the outward extending flange 210b extends.

As noted, the photovoltaic receptacles 216a, 216b at each solar module frame 200 can be configured to receive and retain a plurality of photovoltaic cells 201. Each photovoltaic receptacle 216a, 216b can be defined between a first receptacle wall 217a and a second receptacle wall 217b. Each of the first receptacle wall 217a and the second receptacle wall 217b can extend outward relative to the sidewall 214 in a direction opposite the direction the outward extending flange 210 extends outward from the same sidewall 214. In some examples, such as that shown here, the first and second receptacle walls 217a, 217b, the sidewall 214, and the outward extending flange 210 can be part of a same, single integral material piece (e.g., a shaped aluminum or shaped steel single integral material piece having each of the first and second receptacle walls 217a, 217b, the sidewall 214, and the outward extending flange 210). As shown for the illustrated embodiment here, each photovoltaic receptacle 216a, 216b can be defined, at least in part, by a free-floating end 219 of the receptacle wall 217b that extends in the direction opposite the outward extending flange 210b. Additionally, as shown here, each photovoltaic receptacle 216a, 216b can be further defined by a folded material portion 221 of the receptacle wall 217a such that each photovoltaic receptacle 216a, 216b can be defined between the receptacle wall 217b that includes the free-floating end 219 and the receptacle wall 217a that includes the folded material portion 221. In some examples, the free-floating end 219 of the receptacle wall 217b can be closer to the rail 204 and torque tube 206 than the folded material portion 221.

The help facilitate coupling of the first and second solar module frames 202a, 202b to the torque tube 206, when the first and second solar module frames 202a, 202b are placed at the torque tube 206, outward extending flanges 210a, 210b at the first and second solar module frames 202a, 202b can be configured to overlay one another. For example, as shown at FIG. 2C for an application where the second solar module frame 202b is first placed at the rail 204, the first outward extending flange 210a of the first solar module frame 202a can be configured to overlay the second outward extending flange 210b of the second solar module frame 202b. Here, the first outward extending flange 210a of the first solar module frame 202a can be configured to stack on top of and directly contact the second outward extending flange 210b of the second solar module frame 202b. Or, instead for an application where the first solar module frame 202a is first placed at the rail 204, the second outward extending flange 210b of the second solar module frame 202b can be configured to overlay the first outward extending flange 210a of the first solar module frame 202a.

The overlaid structure of the interfacing outward extending flanges 210a, 210b at the respective first and second solar module frames 202a, 202b can create the fastening gap 212. For example, because the interfacing outward extending flanges 210a, 210b at the respective first and second solar module frames 202a, 202b each extend outward from the respective sidewall 214a, 214b in a direction toward one another (and thus opposite the direction the photovoltaic receptacle 216a, 216b extends from the respective sidewall 214a, 214b), the interfacing outward extending flanges 210a, 210b at the respective first and second solar module frames 202a, 202b can define the fastening gap 212 between the sidewall 214a of the first solar module frame 202a and the sidewall 214b of the second solar module frame 202b. As shown at FIG. 2C, the fastening gap 212 can be defined between the sidewall 214a of the first solar module frame 202a, the sidewall 214b of the second solar module frame 202b, and the stacked first and second outward extending flanges 210a, 210b. As also shown here, the fastening gap 212 can be open at a top side that is opposite the torque tube 206 and thus opposite also to the rail 204 and the stacked first and second outward extending flanges 210a, 210b.

As noted, the solar module coupling system 200 also includes at least one fastener 208. The at least one fastener 208 can, in one example, be a blind fastener as shown at the illustrated embodiment, such as a blind rivet, though other fasteners can be within the scope of this disclosure. The at least one fastener 208 can be configured to couple the first and second solar module frames 202a, 202b to the rail 204 at the torque tube 206. In particular, in some embodiments a single fastener 208 can be configured to extend through the stacked, overlaid first and second outward extending flanges 210a, 210b and into the rail 204 at the torque tube 206 to couple the first and second solar module frames 202a, 202b to the torque tube 206. In other embodiments, such as shown at FIG. 2B, one fastener 208 can be configured to extend through the stacked, overlaid first and second outward extending flanges 210a, 210b and into the rail 204 at the torque tube 206 at first location at the rail 204 to couple the first and second solar module frames 202a, 202b to the torque tube 206, and another fastener 208 can be configured to extend through the stacked, overlaid first and second outward extending flanges 210a, 210b and into the rail 204 at the torque tube 206 at second, spaced apart location at the same rail 204 to couple the first and second solar module frames 202a, 202b to the torque tube 206.

The fastener 208 can be configured to be inserted through the fastening gap 212 from the open, top side of the first and second solar modules frames 202a, 202b opposite the bottom side of the first and second solar modules frames 202a, 202b configured to interface with the torque tube 206. In one such example, this could include inserting the fastener 208 through the fastening gap 212 from the top side that is opposite the rail 204 and torque tube 206 by inserting the fastener 208 through the fastening gap 212 from the top side, then through one of the pair of stacked outward extending flanges 210a, 210b, then through the other of the pair of stacked outward extending flanges 210a, 210b, and then into the rail 204. The configuration noted here to create the fastening gap 212 can be useful for increasing the installation efficiency and throughput associated with installation solar module frames 202 at the torque tube 206 (e.g., by adapting the system 200 to enable a robotic arm installation of the solar module frames 202 from the top side and through the fastening gap 212).

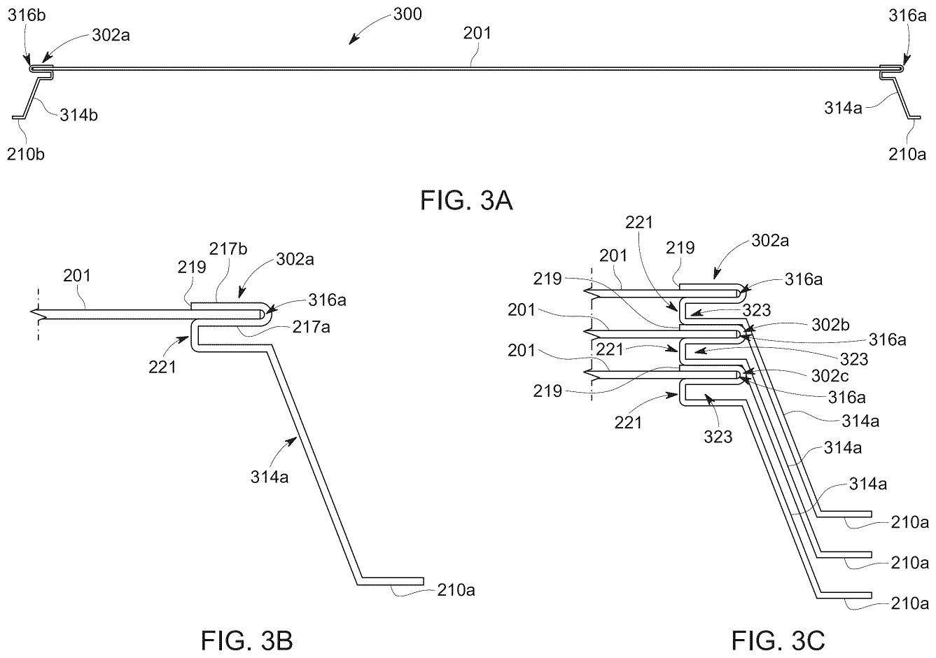

FIGS. 3A-3C illustrate another embodiment of a solar module coupling system 300. FIG. 3A is a side elevational view of a first solar module frame 302a of this system 300 embodiment to be coupled to the torque tube 206, FIG. 3B is a close-up side elevational view of a side end portion of the first solar module frame 302a, and FIG. 3C is a close-up side elevational view of three side end portions of three solar module frames 302a, 302b, 302c stacked on top of one another. Except as otherwise described or illustrated here with respect to FIGS. 3A-3C, the solar module coupling system 300 and the solar module frames 302a, 302b, 302c can be similar to, or the same as, that disclosed elsewhere herein with respect to the solar modules frames 200 (e.g., with respect to solar module frames 202a, 202b).

As shown for the system 300 embodiment at FIGS. 3A-3C, solar module frames 302a, 302b, 302c can each include sidewalls 314a, 314b at opposite end portions and outward extending flanges 210a, 210b at opposite end portions. For example, as shown here, each solar module frame 302a, 302b, 302c can include sidewall 314a and outward extending flange 210a at a first longitudinal side and can include sidewall 314b and outward extending flanges 210b at a second longitudinal side that is opposite the first longitudinal side. Different from the embodiment of the solar module frames 200, each of the solar module frames 302a, 302b, 302c can include the sidewall 314a and the sidewall 314b extending vertically, at a skewed angle, from the respective outward extending flange 210a, 210b. In particular, each of the solar module frames 302a, 302b, 302c can include the sidewall 314a extending vertically, at a skewed angle relative to the first outward extending flange 210a, between the first outward extending flange 210a and a first photovoltaic receptacle 316a at each of the solar module frames 302a, 302b, 302c, and each of the solar module frames 302a, 302b, 302c can include the sidewall 314b extending vertically, at a skewed angle relative to the second outward extending flange 210b, between the second outward extending flange 210b and a second photovoltaic receptacle 316b at each of the solar module frames 302a, 302b, 302c.

The photovoltaic receptacles 316a, 316b can differ from the photovoltaic receptacles 216, 216b of the previous embodiment in that the orientation of the free-floating end 219 and the folded material portion 221 can be reversed. Namely, for each of the solar module frames 302a, 302b, 302c, each photovoltaic receptacle 316a, 316b can be formed between free-floating end 219 and folded material portion 221 at each photovoltaic receptacle 316a, 316b. As shown for the illustrated embodiment here, the free-floating end 219 of receptacle wall 217b can be further from the rail 204 and torque tube 206 than the folded material portion 221. In such an arrangement with the folded material portion 221 below the photovoltaic cells 201, the folded material portion 221 can act to provide additional structural support to counteract the weight of the photovoltaic cells 201 received and supported at the photovoltaic receptacle 316a, 316b.

In addition to the same, or similar, useful features noted with the previous embodiment of the solar module frames 202a, 202b, the structure of the solar module frames 302a, 302b, 302c can be useful, for example as shown at FIG. 3C, in increasing a packing/shipping density of solar module frames 302a, 302b, 302c. As shown at the example of FIG. 3C, solar module frames 302a, 302b, 302c can be stacked on top of one another. The folded material portion 221, below the photovoltaic receptacles 316a, 316b at each side of the solar module frames 302a, 302b, 302c, can define a junction box stowage receptacle 323. One or more (e.g., each) of the junction box stowage receptacles 323 can be configured to accommodate and receive a junction box when stacked and packaged while also helping to create an isolation space between the photovoltaic cells 201 to prevent damage to the photovoltaic cells 201 during packaging and shipping.

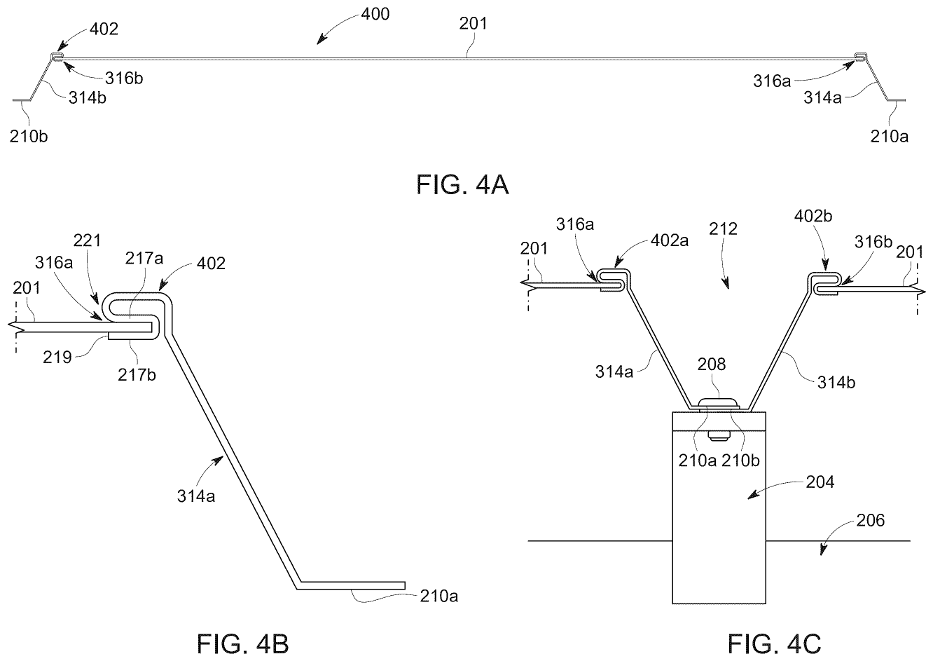

FIGS. 4A-4C illustrate an additional embodiment of a solar module coupling system 400. FIG. 4A is a side elevational view of a first solar module frame 402 of this system 400 embodiment to be coupled to torque tube 206, FIG. 4B is a close-up side elevational view of a side end portion of the first solar module frame 402, and FIG. 4C is a side elevational view of the first and second solar module frames 402a, 402b along with the rail 204 coupled to the torque tube 206. For example, the solar module frames 402 (e.g., solar module frames 402a, 402b) can be similar to, or the same as, that disclosed elsewhere herein with respect to the solar modules frames 200 (e.g., with respect to solar module frames 202a, 202b) except as otherwise described or illustrated here with respect to FIGS. 4A-4C.

In particular, the solar module frames 402a, 402b can be similar to, or the same as, solar module frames 202a, 202b as previously described except that each solar module frame 402a, 402b can include sidewalls 314a, 314b, at opposite end portions, extending vertically at but at a skewed angle. In addition to the skewed sidewalls 314a, 314b, each solar module frame 402, 402b can include the outward extending flanges 210a, 210b at opposite end portions. For example, as shown here, each solar module frame 402a, 402b can include sidewall 314a and outward extending flange 210a at a first longitudinal side and can include sidewall 314b and outward extending flanges 210b at a second longitudinal side that is opposite the first longitudinal side. Different from the embodiment of the solar module frames 200, each of the solar module frames 402a, 402b can include the sidewall 314a and the sidewall 314b extending vertically, at a skewed angle, from the respective outward extending flange 210a, 210b. In particular, each of the solar module frames 402a, 402b can include the sidewall 314a extending vertically, at a skewed angle relative to the first outward extending flange 210a, between the first outward extending flange 210a and first photovoltaic receptacle 316a at each of the solar module frames 402a, 402b, and each of the solar module frames 402a, 402b can include the sidewall 314b extending vertically, at a skewed angle relative to the second outward extending flange 210b, between the second outward extending flange 210b and second photovoltaic receptacle 316b at each of the solar module frames 402, 402b. Similar to that described previously, this frame structure can be useful in increasing a packaging/shipping density associated with a plurality of such solar module frames 402. Also, this skewed wall frame structure can be useful in increasing a size of the fastening gap 212 top side opening, for instance, to facilitate easier top-side fastener 208 installation through the fastening gap 212.

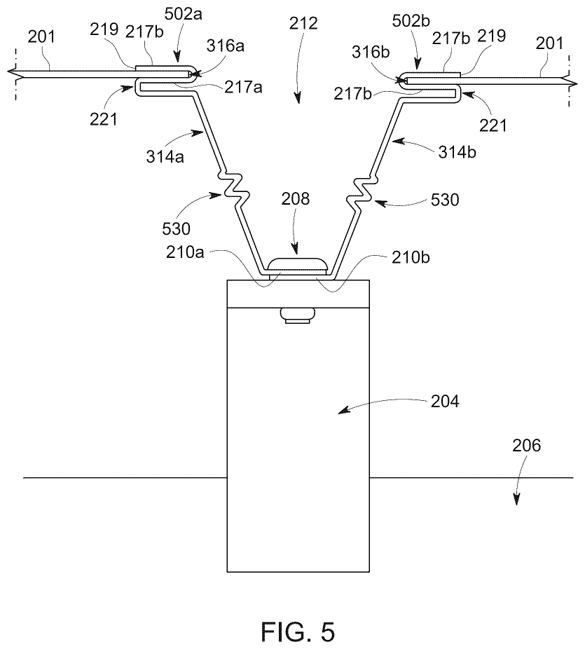

FIG. 5 shows a side elevational view of another embodiment of a solar module frame 502. More specifically, FIG. 5 shows a side elevational view of first and second solar module frames 502a, 502b according to this embodiment as well as the rail 204 coupled to the torque tube 206. In certain embodiments, except as otherwise described or illustrated here with respect to FIG. 5, the solar module frames 502a, 502b can be similar to, or the same as, the solar module frames 302 (e.g., solar module frames 302a, 302b) described at illustrated at FIGS. 3A-3C.

For the illustrated embodiment, solar module frames 502a, 502b can be similar to, or the same as, the solar module frames 302 (e.g., solar module frames 302a, 302b) described at illustrated at FIGS. 3A-3C except that the solar module frames 502a, 502b can each include a corrugated portion 530. As illustrated for the example shown here at FIG. 5, solar module frame 502a can include the sidewall 314a extending at the skewed angle between the outward extending flange 210a and the photovoltaic receptacle 316a, and solar module frame 502b can include the sidewall 314b extending at the skewed angle between the outward extending flange 210b and the photovoltaic receptacle 316b. The sidewall 314a of the solar module frame 502a can include corrugated portion 530, and, likewise, the sidewall 314b of the solar module frame 502b can include corrugated portion 530 (e.g., solar module frame 502a can include the same features at its other opposite longitudinal side, as disclosed elsewhere herein; solar module frame 502b can include the same features at its other opposite longitudinal side, as disclosed elsewhere herein). The corrugated portion 530 can be defined along a portion, or all, of the length of the vertical, skewed extent of the respective sidewall 314a, 314b. Thus, the sidewall 314a can include a first corrugated portion 530 that extends vertically, at the skewed angle relative to the first outward extending flange 210a, between the first outward extending flange 210a and the first photovoltaic receptacle 316a at the solar module frame 502a, and the sidewall 314b can include a second corrugated portion 530 that extends vertically, at the skewed angle relative to the second outward extending flange 210b, between the second outward extending flange 210b and the second photovoltaic receptacle 316b at the solar module frame 502b.

The corrugated portion 530 can be configured to dampen vibrational energy as vibration energy attempts to transfer from the torque tube 206 to solar module frames 502a, 502b. In particular, corrugated portion 530 can be configured to dampen vibration energy from the rail 204 as this vibrational energy is imparted along the respective sidewall 314a, 314b and prior to this vibrational energy reaching the respective photovoltaic receptacles 316a, 316b. The corrugated portion 530 can, in some examples, include one or more folds of material, such that the corrugated portion 530 at the respective sidewall 314a, 314b can include a type of waveform shape along the respective sidewall 314a, 314b that can act to elongate the distance vibrational energy is required to travel from the stacked, overlaid outward extending flanges 210a, 210b (e.g., that interface with the rail 204) to the respective photovoltaic receptacles 316a, 316b. Thus, the corrugated portion 530 can act to reduce the magnitude of vibrational energy imparted from the solar tracker (e.g., from the torque tube 206) to the photovoltaic receptacles 316a, 316b.

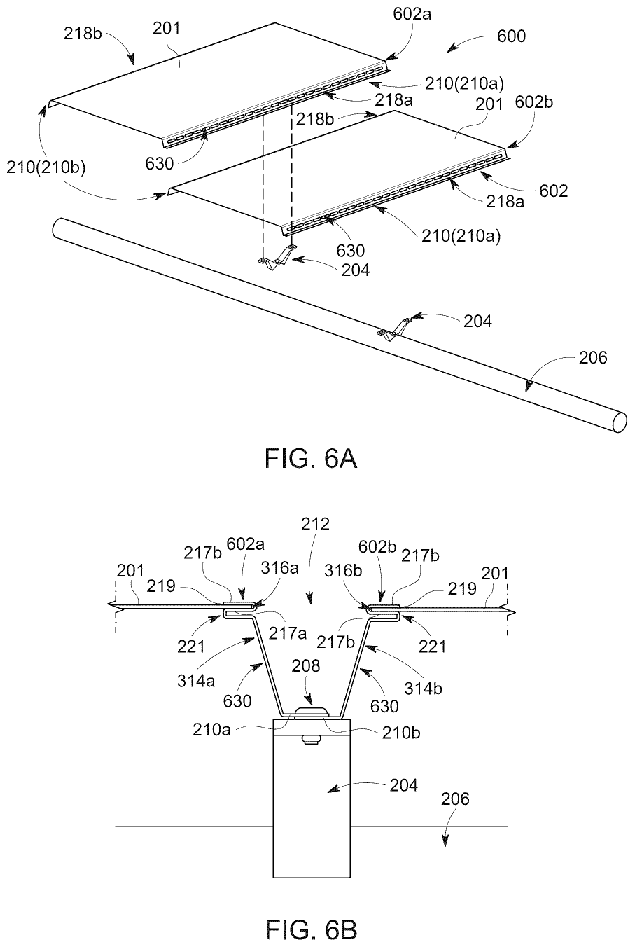

FIGS. 6A-6B illustrate an additional embodiment of a solar module coupling system 600. FIG. 6A is an exploded, perspective view of first and second solar module frames 602a, 602b and rail 204 of this system 600 to be coupled to the torque tube 206, and FIG. 6B is a side elevational view of the first and second solar module frames 602a, 602b along with rail 204 coupled to the torque tube 206. In certain embodiments, except as otherwise described or illustrated here with respect to FIGS. 6A and 6B, the solar module frames 602a, 602b can be similar to, or the same as, the solar module frames 302 (e.g., solar module frames 302a, 302b) described at illustrated at FIGS. 3A-3C.

For the illustrated embodiment, solar module frames 602a, 602b can be similar to, or the same as, the solar module frames 302 (e.g., solar module frames 302a, 302b) described at illustrated at FIGS. 3A-3C except that the solar module frames 602a, 602b can each include a plurality of damping slots 630 at one or more sidewalls of each solar module frame 602a, 602b. As illustrated for the example shown here at FIGS. 6A-6B, solar module frame 602a can include the sidewall 314a extending at the skewed angle between the outward extending flange 210a and the photovoltaic receptacle 316a, and solar module frame 602b can include the sidewall 314b extending at the skewed angle between the outward extending flange 210b and the photovoltaic receptacle 316b. The sidewall 314a of the solar module frame 602a can include a first plurality of damping slots 630, and, likewise, the sidewall 314b of the solar module frame 602b can include a second plurality of damping slots 630 (e.g., solar module frame 602a can include the sidewall 314b and the plurality of damping slots 630 at its opposite side 218b too; solar module frame 602b can include the sidewall 314a and the plurality of damping slots 630 at its opposite side 218a too). The plurality of damping slots 630 can be defined along a portion, but not all, of the length of the vertical, skewed extent of the respective sidewall 314a, 314b. Thus, the sidewall 314a can include a first plurality of damping slots 630 that each extend vertically, at the skewed angle relative to the first outward extending flange 210a, along some but not all of the extent of the sidewall 314a between the first outward extending flange 210a and the first photovoltaic receptacle 316a at the solar module frame 602a, and the sidewall 314b can include a second plurality of damping slots 630 that each extend vertically, at the skewed angle relative to the second outward extending flange 210b, along some but not all of the extent of the sidewall 314b between the second outward extending flange 210b and the second photovoltaic receptacle 316b at the solar module frame 602b.

The plurality of damping slots 630 can be configured to dampen vibrational energy as vibration energy attempts to transfer from the torque tube 206 to solar module frames 502a, 502b. In particular, the plurality of damping slots 630 can be configured to dampen vibration energy from the rail 204 as this vibrational energy is imparted along the respective sidewall 314a, 314b and prior to this vibrational energy reaching the respective photovoltaic receptacles 316a, 316b. As one such example, the plurality of damping slots 630 can be configured to permit flexing of the respective sidewall 314a, 314b that can act to absorb, via this induced flexing of the respective sidewall 314a, 314b, at least some vibrational energy prior to this vibration energy reaching the photovoltaic receptacles 316a, 316b. Thus, the plurality of damping slots 630 can act to reduce the magnitude of vibrational energy imparted from the solar tracker (e.g., from the torque tube 206) to the photovoltaic receptacles 316a, 316b.

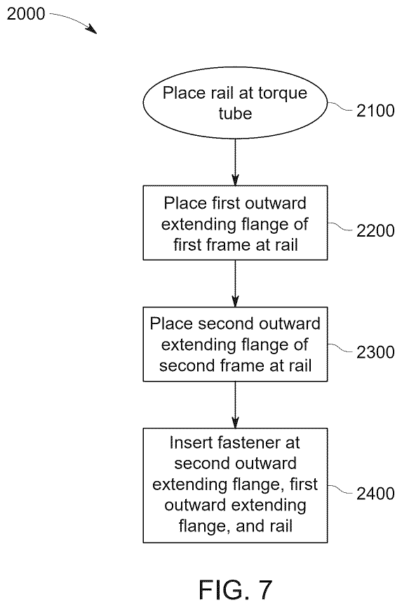

FIG. 7 is a flow diagram of an embodiment of a method 2000 for coupling a first solar module frame and a second solar module frame to a torque tube. The method 2000 can be executed, for example, using any one or more of the various embodiments of solar module frames and solar module coupling systems disclosed elsewhere herein.

At step 2100, the method 2000 includes placing a rail at a torque tube. For example, the rail can be placed at the torque tube of a solar tracker and then the rail can be secured to the torque tube. As one such example, after placing the rail at the torque tube at step 2100 but before placing the first and second outward extending flanges at the rail at steps 2200 and 2300, method 2000 can include inserting a fastener (e.g., different than the fastener inserted though the fastening gap through the top side) at the rail to couple the rail to the torque tube. For instance, the rail can include a central region where this fastener can be inserted, while the rail can include wing end portion at opposite sides of this central region (e.g., where fastener 208 can be inserted through the fastening gap through the top side and through the overlaid, stacked outward extending flanges interfacing with the rail at the wing end portions of the rail). The rail (e.g., rail 204) placed at the torque tube can include a bottom side that defines a cross sectional profile (e.g., semi-circular) to the cross-sectional profile of the torque tube (e.g., circular).

At step 2200, the method 2000 includes placing a first outward extending flange of a first solar module frame at the rail. For example, the first outward extending flange of the first solar module frame can be placed at the rail such that the first outward extending flange directly contacts the rail. This could include, in one instance, placing the first outward extending flange into direct contact with the rail at one of the wing end portions at one side of the central portion of the rail and also at another wing end portion at another, opposite side of the central portion of the rail (e.g., such as shown at FIG. 2B where rail 204 has wing end portions 204a, 204b and central portion 204c that is at a different-e.g., lower-elevation than the wing end portions 204a, 204b).

At step 2300, the method 2000 includes placing a second outward extending flange of a second solar module frame over the first outward extending flange at the rail. For example, the second outward extending flange can be placed over the first outward extending flange of the first solar module frame at the rail after the first outward extending flange of the first solar module frame is placed at the rail. The second outward extending flange can be placed over the first outward extending flange at the rail by stacking the second outward extending flange on top of the first outward extending flange at the rail. For example, the first outward extending flange can be placed at step 2200 at the rail to directly contact the rail, and the second outward extending flange can at step 2300 be stacked on top of the first outward extending flange at the rail such that the second outward extending flange directly contacts the first outward extending flange to create the overlaid, stack of the pair of outwardly extending flanges at each of the solar module frames placed at a common rail.

As one example at step 2300, the second outward extending flange of the second solar module frame can be stacked on top of the first outward extending flange of the first solar module frame at the common rail to define a fastening gap. Thus, in executing steps 2200 and 2300, the method 2000 can include creating the fastening gap between first and second solar module frames as a result of overlaying the outward extending flanges of the first and second solar module frames. For instance, this fastening gap can be defined between the first sidewall of the first solar module frame, the second sidewall of the second solar module frame, and the stacked first and second outward extending flanges. This fastening gap can be open at a top side that is opposite the rail.

At step 2400, the method 2000 includes inserting a fastener at the second outward extending flange, the first outward extending flange, and the rail. For instance, inserting the fastener at step 2400 can be executed, in some applications, by inserting a single fastener to extend through the stacked, overlaid first and second outward extending flanges of the first and second solar module frames and into the rail at the torque tube to couple the first and second solar module frames to the torque tube.

In some examples, as noted at step 2300, the fastening gap can be created between the first sidewall of the first solar module frame, the second sidewall of the second solar module frame, and the stacked first and second outward extending flanges. Then at step 2400, this fastening gap can be used to insert the fastener. In particular, inserting the fastener at the second outward extending flange, the first outward extending flange, and the rail at step 2400 can include inserting the fastener through the fastening gap from the top side that is opposite the rail. For instance, inserting the fastener through the fastening gap from the top side that is opposite the rail can include inserting the fastener through the fastening gap from the top side, then through the second outward extending flange, then through the first outward extending flange, and then into the rail. Thus, in some applications of the method 2000, the fastener can be inserted at the second outward extending flange, the first outward extending flange, and the rail through an open top side of the fastening gap that is defined between first solar module frame and the second solar module frame. To help facilitate this, the fastening gap can define a fastening gap width, and the fastening gap width can be greater than a width of the fastener. As one such example, the fastener can be a blind fastener (e.g., a blind rivet), and the fastening gap width can be greater than a width of the blind fastener (e.g., greater than a width of a blind rivet).

Various examples have been described. These and other examples are within the scope of the following claims.

What is claimed is:

1. A method for coupling a first solar module frame and a second solar module frame to a torque tube, the method comprising the steps of:
placing a rail at the torque tube;
placing a first outward extending flange of the first solar module frame at the rail;
placing a second outward extending flange of the second solar module frame over the first outward extending flange at the rail; and
inserting a fastener at the second outward extending flange, the first outward extending flange, and the rail.

2. The method of claim 1, wherein the second outward extending flange is placed over the first outward extending flange at the rail after the first outward extending flange is placed at the rail.

3. The method of claim 2, wherein the second outward extending flange is placed over the first outward extending flange at the rail by stacking the second outward extending flange on top of the first outward extending flange at the rail.

4. The method of claim 3,
wherein the first outward extending flange is placed at the rail to directly contact the rail, and
wherein the second outward extending flange is stacked on top of the first outward extending flange at the rail such that the second outward extending flange directly contacts the first outward extending flange.

5. The method of claim 3,
wherein the first outward extending flange of the first solar module frame extends horizontally outward from a first sidewall of the first solar module frame,
wherein the second outward extending flange of the second solar module frame extends horizontally outward from a second sidewall of the second solar module frame, and
wherein the second outward extending flange is stacked on top of the first outward extending flange at the rail to define a fastening gap between the first sidewall of the first solar module frame, the second sidewall of the second solar module frame, and the stacked first and second outward extending flanges.

6. The method of claim 5, wherein the fastening gap is open at a top side that is opposite the rail.

7. The method of claim 6, wherein inserting the fastener at the second outward extending flange, the first outward extending flange, and the rail comprises inserting the fastener through the fastening gap from the top side that is opposite the rail.

8. The method of claim 7, wherein inserting the fastener through the fastening gap from the top side that is opposite the rail comprises inserting the fastener through the fastening gap from the top side, then through the second outward extending flange, then through the first outward extending flange, and then into the rail.

9. The method of claim 5,
wherein the first solar module frame further comprises a first photovoltaic receptacle, the first photovoltaic receptacle extending horizontally outward from the first sidewall in a direction opposite the first outward extending flange and opposite the fastening gap,
wherein the second solar module frame further comprises a second photovoltaic receptacle, the second photovoltaic receptacle extending horizontally outward from the second sidewall in a direction opposite the second outward extending flange and opposite the fastening gap.

10. The method of claim 1, further comprising:
after placing the rail at the torque tube and before placing the first and second outward extending flanges at the rail, inserting a second fastener at the rail to couple the rail to the torque tube.

11. The method of claim 1, wherein the fastener is inserted at the second outward extending flange, the first outward extending flange, and the rail through an open top side of a fastening gap that is defined between first solar module frame and the second solar module frame.

12. The method of claim 11, wherein the fastening gap defines a fastening gap width, and wherein the fastening gap width is greater than a width of the fastener.

13. A solar module coupling system comprising:
a first solar module frame comprising a first sidewall, a first outward extending flange that extends out horizontally from the first sidewall, and a first photovoltaic receptacle that extends out horizontally from the first sidewall in a direction opposite the first outward extending flange;
a second solar module frame comprising a second sidewall, a second outward extending flange that extends out horizontally from the second sidewall, and a second photovoltaic receptacle that extends out horizontally from the second sidewall in a direction opposite the second outward extending flange, wherein the second outward extending flange is configured to overlay the first outward extending flange; and
a fastener configured to couple the first and second solar module frames to a rail at a torque tube, wherein, when the second outward extending flange overlays first outward extending flange, the fastener is configured to extend through the overlaid first and second outward extending flanges and into the rail at the torque tube.

14. The system of claim 13, wherein, when the second outward extending flange overlays first outward extending flange, the first and second outward extending flanges are configured to create a fastening gap between the first sidewall of the first solar module frame, the second sidewall of the second solar module frame, and the overlaid first and second outward extending flanges.

15. The system of claim 14, wherein the fastener is configured to be inserted through the fastening gap from a top side of the first and second solar modules frames opposite a bottom side of the first and second solar modules frames configured to interface with a torque tube.

16. The system of claim 13,
wherein the first sidewall extends vertically, at a normal angle relative to the first outward extending flange, between the first outward extending flange and the first photovoltaic receptacle, and
wherein the second sidewall extends vertically, at a normal angle relative to the second outward extending flange, between the second outward extending flange and the second photovoltaic receptacle.

17. The system of claim 16,
wherein the first photovoltaic receptacle is defined, at least in part, by a free-floating end of a first photovoltaic receptacle wall that extends in a direction opposite the first outward extending flange, and
wherein the second photovoltaic receptacle is defined, at least in part, by a free-floating end of a second photovoltaic receptacle wall that extends in a direction opposite the second outward extending flange.

18. The system of claim 13, wherein the first sidewall extends vertically, at a skewed angle relative to the first
outward extending flange, between the first outward extending flange and the first photovoltaic receptacle, and
wherein the second sidewall extends vertically, at a skewed angle relative to the second outward extending flange, between the second outward extending flange and the second photovoltaic receptacle.

19. The system of claim 18,
wherein the first sidewall includes a first corrugated portion that extends vertically, at the skewed angle relative to the first outward extending flange, between the first outward extending flange and the first photovoltaic receptacle, and
wherein the second sidewall includes a second corrugated portion that extends vertically, at the skewed angle relative to the second outward extending flange, between the second outward extending flange and the second photovoltaic receptacle.

20. The system of claim 13,
wherein the first solar module frame further comprises a first plurality of damping slots at the first sidewall, the first plurality of damping slots configured to permit flexing of the first sidewall, and
wherein the second solar module frame further comprises a second plurality of damping slots at the second sidewall, the second plurality of damping slots configured to permit flexing of the second sidewall.
